(19) United States
(12) Patent Application Publication
(10) Pub. No.: US 2026/0290337 A1
(43) Pub. Date: Sep. 24, 2026

(54) METHOD FOR ENHANCING SPEECH RECOGNITION BASED ON MEETING INFORMATION AND COMPUTING DEVICE USING SAME

(71) Applicant: SAMSUNG SDS CO., LTD., Seoul (KR)

(72) Inventors: Junho KANG, Seoul (KR); Heetae YOON, Seoul (KR); Youngkwang KIM, Seoul (KR)

(73) Assignee: SAMSUNG SDS CO., LTD., Seoul (KR)

(21) Appl. No.: 19/300,086

(22) Filed: Aug. 14, 2025

(30) Foreign Application Priority Data
Mar. 20, 2025 (KR) 10-2025-0036231
Jul. 16, 2025 (KR) 10-2025-0096309

(51) Int. Cl. G10L 15/22; G10L 15/08

(52) U.S. Cl. CPC G10L 15/22; G10L 15/08; G10L 2015/088

(57) ABSTRACT

The present disclosure relates to a method for enhancing speech recognition based on meeting information, and a computing device using the same. A method for enhancing speech recognition based on meeting information using a computing device, according to an embodiment of the present disclosure, may include: extracting meeting information corresponding to a meeting session held online; extracting keywords from the meeting information and setting keyword-specific boosting values corresponding to the keywords to generate a boosting list; and applying the boosting list to a speech recognition model to increase a recognition probability of the keywords for input speech.

### CROSS-REFERENCE TO RELATED APPLICATION(S)

This application claims priority under 35 U.S.C. 119 to Korean Patent Application Nos. 10-2025-0036231, filed on Mar. 20, 2025, and 10-2025-0096309, filed on Jul. 16, 2025 in the Korean Intellectual Property Office, the disclosures of which are incorporated by reference in their entirety.

### BACKGROUND OF THE INVENTION

### 1. Field of the Invention

The present disclosure relates to a method for enhancing speech recognition based on meeting information, which effectively recognizes the speech of participants during a meeting and converts it into text, and a computing device using the same.

### 2. Description of the Prior Art

A speech recognition model (Automatic Speech Recognition (ASR)) may recognize input speech and output text corresponding to the speech. Here, if individual words have distinct pronunciations, enabling accurate identification of words based solely on speech, the recognition accuracy of the speech recognition model for recognizing words may be very high. However, actually, many words have identical or similar pronunciations, making it difficult to accurately identify the correct word based on speech alone.

Previously, accuracy was improved by fine-tuning speech recognition models depending on specific environments in which speech occurs (e.g., telemedicine or online banking). However, this approach presented a problem in that significant time and cost are required for additional training.

Recently, a technique has been introduced to improve the accuracy of speech recognition models by specifying individual words and setting boosting values without requiring separate training. In other words, it is possible to improve the recognition rate for desired words by selecting and inputting the words, instead of spending significant time and money on fine-tuning.

### SUMMARY OF THE INVENTION

The present disclosure has been made in order to solve the above-mentioned problems in the prior art and an aspect of the present disclosure is to provide a method for enhancing speech recognition based on meeting information, which boosts the log probability of keywords used in a meeting session during speech recognition model inference, thereby enabling accurate speech recognition for those keywords, and a computing device using the same.

Another aspect of the present disclosure is to provide a method for enhancing speech recognition based on meeting information, which is capable of improving the accuracy of a speech recognition model by providing a boosting list without a separate training process, and a computing device using the same.

Another aspect of the present disclosure is to provide a method for enhancing speech recognition based on meeting information, which collects meeting information in various ways to improve the accuracy of a speech recognition model, and a computing device using the same.

According to an embodiment of the present disclosure, a method for enhancing speech recognition based on meeting information using a computing device may include: extracting meeting information corresponding to a meeting session held online; extracting keywords from the meeting information and setting keyword-specific boosting values corresponding to the keywords to generate a boosting list; and applying the boosting list to a speech recognition model to increase a recognition probability of the keywords for input speech.

Here, the extracting of the meeting information may include extracting at least one of a meeting session title, an agenda, names, affiliations, connection locations, and connection times of participants as the meeting information.

Here, the extracting of the meeting information may include extracting, as the meeting information, document text extracted from a document shared in the meeting session or screen text extracted from a screen capture image of a screen shared in the meeting session.

Here, the generating of the boosting list may include inputting the meeting information into a large language model (LLM) and requesting extraction of keywords corresponding thereto.

Here, the speech recognition model may produce log probabilities of multiple candidate sequences corresponding to the input speech, and then add the keyword-specific boosting value to a log probability of a candidate sequence corresponding to the keyword, among the multiple candidate sequences.

Here, the method for enhancing speech recognition based on meeting information according to an embodiment of the present disclosure may further include generating conversation text corresponding to speech of participants in the meeting session using the speech recognition model to which the boosting list has been applied.

Here, the generating of the conversation text may include generating minutes for the meeting session, which include the conversation text, and verifying and correcting the minutes, based on a large language model.

Here, the extracting of the meeting information may include extracting the meeting information from the minutes.

Here, the method for enhancing speech recognition based on meeting information according to an embodiment of the present disclosure may further include storing the boosting list corresponding to the meeting session in a boosting database.

Here, the extracting of the meeting information may include extracting a previous boosting list for each participant in the meeting session from the boosting database, and extracting the meeting information from the previous boosting list.

Here, the generating of the boosting list may include reconfiguring frequently used keywords in the previous boosting list as keywords for the meeting session.

A computer program according to an embodiment of the present disclosure may be stored on a computer-readable medium for executing, in conjunction with hardware, the method for enhancing speech recognition based on meeting information described above.

A computing device performing meeting information-based speech recognition enhancement, according to an embodiment of the present disclosure, may include a processor, wherein the processor may be configured to: extract meeting information corresponding to a meeting session held online; extract keywords from the meeting information and set keyword-specific boosting values corresponding to the keywords to generate a boosting list; and apply the boosting list to a speech recognition model to increase a recognition probability of the keywords for input speech.

Here, the extracting of the meeting information may include extracting at least one of a meeting session title, an agenda, names, affiliations, connection locations, and connection times of participants as the meeting information.

Here, the extracting of the meeting information may include extracting, as the meeting information, document text extracted from a document shared in the meeting session or screen text extracted from a screen capture image of a screen shared in the meeting session.

Here, the generating of the boosting list may include inputting the meeting information into a large language model (LLM) and requesting extraction of keywords corresponding thereto.

Here, the speech recognition model may be configured to produce log probabilities of multiple candidate sequences corresponding to the input speech, and then add the keyword-specific boosting value to a log probability of a candidate sequence corresponding to the keyword, among the multiple candidate sequences.

Here, the processor may be further configured to generate conversation text corresponding to speech of participants in the meeting session using the speech recognition model to which the boosting list has been applied.

Here, the processor may be further configured to store the boosting list corresponding to the meeting session in a boosting database.

Here, the extracting of the meeting information may include extracting a previous boosting list for each participant in the meeting session from the boosting database, and extracting the meeting information from the previous boosting list.

In addition, it should be noted that the above-described solutions to the problem do not represent an exhaustive listing of the features of the present disclosure. Various features of the present disclosure and advantages and effects according thereto will be more apparently understood with reference to the following detailed embodiments.

According to a method for enhancing speech recognition based on meeting information in accordance with an embodiment of the present disclosure and a computing device using the same, since the log probability of keywords used in a meeting session can be boosted during speech recognition model inference, it is possible to perform accurate speech recognition for the relevant keywords.

According to a method for enhancing speech recognition based on meeting information in accordance with an embodiment of the present disclosure and a computing device using the same, the accuracy of a speech recognition model can be improved by providing a boosting list without a separate training process for improving the accuracy of the speech recognition model. Therefore, it is possible to reduce the cost and time required for additional training, such as fine-tuning of the speech recognition model.

However, the effects obtainable from the method for enhancing speech recognition based on meeting information according to the embodiments of the present disclosure and the computing device using the same are not limited to those described above, and other effects not mentioned above will be clearly understood by those skilled in the art to which the present disclosure pertains from the description below.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a schematic diagram illustrating a speech recognition enhancement system based on meeting information according to an embodiment of the present disclosure;

FIG. 2 is an exemplary diagram illustrating a speech recognition model pipeline according to an embodiment of the present disclosure;

FIG. 3 is a block diagram illustrating a speech recognition enhancement device according to an embodiment of the present disclosure;

FIG. 4 is a schematic diagram illustrating the operation of a speech recognition enhancement device utilizing an LLM according to an embodiment of the present disclosure;

FIG. 5 is a diagram illustrating an example of setting keyword-specific boosting values according to an embodiment of the present disclosure;

FIG. 6 is a schematic diagram illustrating the operation of a speech recognition enhancement device utilizing shared information during a conversation session according to an embodiment of the present disclosure;

FIG. 7 is a schematic diagram illustrating the operation of a speech recognition enhancement device utilizing minutes according to an embodiment of the present disclosure;

FIG. 8 is a block diagram illustrating a computing environment suitable for use in exemplary embodiments of the present disclosure; and

FIG. 9 is a flowchart illustrating a method for enhancing speech recognition based on meeting information according to an embodiment of the present disclosure.

### DETAILED DESCRIPTION OF THE EXEMPLARY EMBODIMENTS

Hereinafter, the embodiments disclosed in this specification will be described in detail with reference to the attached drawings. Regardless of the reference numerals, identical or similar elements will be assigned the same reference numerals, and redundant descriptions thereof will be omitted. The terms “module” and “unit” used for elements in the following description are assigned or used interchangeably only for the convenience of drafting the specification, and do not have distinct meanings or roles in themselves. That is, the term “unit” used in the present disclosure indicates software or a hardware element such as FPGA or ASIC, and the “unit” performs a certain role. However, the “unit” is not limited to software or hardware. The “unit” may be configured to reside in an addressable storage medium or may be configured to reproduce one or more processors. Accordingly, as an example, “units” include elements such as software elements, object-oriented software elements, class elements, and task elements, processes, functions, properties, procedures, subroutines, segments of program code, drivers, firmware, microcode, circuits, data, databases, data structures, tables, arrays, and variables. The functions provided by the elements and “units” may be combined into a smaller number of elements and “units” or may be further divided into additional elements and “units.”

In addition, in describing the embodiments disclosed in this specification, a detailed description of a related known technology, which may obscure the subject matter of the embodiments disclosed in this specification, will be omitted. In addition, the attached drawings are only intended to facilitate easy understanding of the embodiments disclosed in this specification, and the technical ideas disclosed in this specification are not limited to the attached drawings, and should be understood to encompass all modifications, equivalents, or substitutes included in the scope of the disclosure.

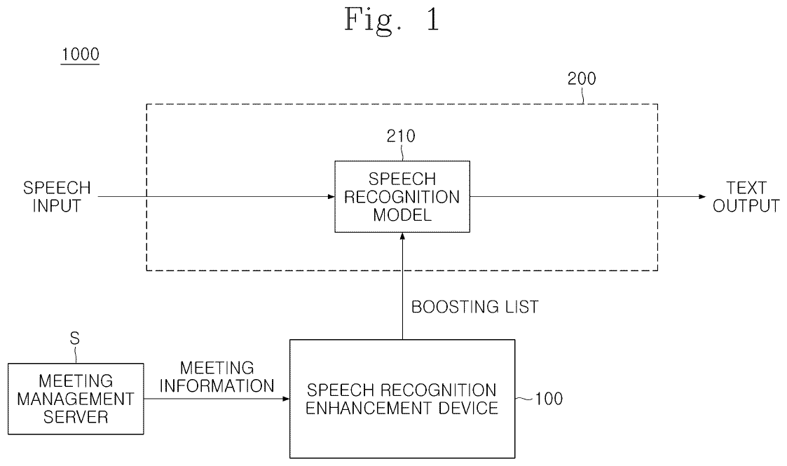

FIG. 1 is a schematic diagram illustrating a speech recognition enhancement system based on meeting information according to an embodiment of the present disclosure.

Referring to FIG. 1, the speech recognition enhancement system 1000 according to an embodiment of the present disclosure may include a meeting management server S, a speech recognition enhancement device 100, and a speech recognition device 200.

Hereinafter, the speech recognition enhancement system 1000 according to an embodiment of the present disclosure will be described with reference to FIG. 1.

The meeting management server S may provide video meeting services between the terminal devices (not shown). The meeting management server S may relay the transmission of media data between the terminal devices during a meeting session, or may configure P2P (Peer-to-Peer) communication between the terminal devices. Here, media data may include image data, voice data, or the like generated during the video meeting. For example, image data may include an image of a user captured by the camera of the terminal device during the meeting session, a screen sharing image for the screen displayed on a display in the terminal device during screen sharing, or the like. In addition, voice data may include the user's speech or sound effects input through a microphone of the terminal device.

When providing video meeting services, the meeting management server S may further provide various generative AI-based services. That is, generative AI-based services may be provided based on resources such as a processor and a memory provided in the meeting management server S, and the meeting management server S may have various generative AI-based models constructed. Here, some generative AI models may perform operations such as natural language processing or the like in conjunction with a large language model (LLM). For example, the meeting management server S may automatically generate minutes for the video meeting or provide services such as summarizing and translating the minutes using the generative AI.

The terminal device may connect to the meeting management server S using wired or wireless networks, and receive video meeting services through the meeting management server S. That is, the users may attend the online meeting session using their terminal devices and conduct online video meetings with other participants.

The terminal device may include a communication module for transmitting and receiving information, a memory for storing programs and protocols, a processor for executing various programs and performing calculations and control, or the like. Additionally, the terminal device may further include devices such as a camera, a microphone, a speaker, and a display for conducting video meetings. The respective devices may be provided inside the terminal device or may be connected to the terminal device through wired or wireless communication.

The terminal devices may be mobile terminals such as smartphones, tablet PCs, or the like, or stationary terminals such as desktop PCs or the like. For example, the terminal devices may include mobile phones, smartphones, laptop computers, digital broadcasting terminals, personal digital assistants (PDAs), a portable multimedia players (PMPs), slate PCs, tablet PCs, ultra-book devices, wearable devices (e.g., smartwatches, smart glasses, or head-mounted displays (HMDs)), and the like.

The speech recognition device (ASR (Automatic Speech recognition)) 200 may be included in the terminal device or meeting management server S, and may generate text corresponding to the user's input speech using the speech recognition model 210. The following description will be made based on an example where the speech recognition device 200 is provided in the meeting management server S.

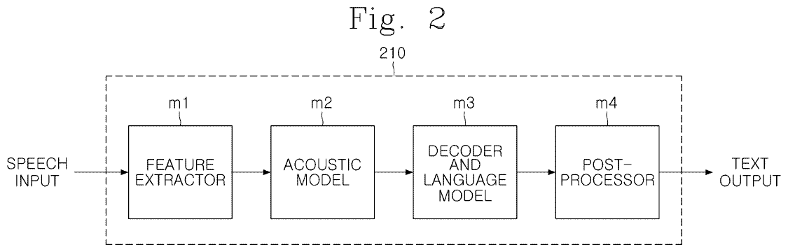

Referring to FIG. 2, the speech recognition model 210 may include a feature extractor m1, an acoustic model m2, a decoder and language model m3, and a post-processor m4.

The feature extractor m1 may convert an input speech signal into a frequency-based feature vector for a specific time frame. For example, the feature extractor m1 may generate the Mel-spectrogram or the Mel-Frequency Cepstral Coefficients (MFCC) as the feature vector.

The acoustic model m2 may predict the probability distribution for corresponding phonemes, characters, subwords, or tokens using the feature vector. The acoustic model m2 may be implemented based on the Hidden Markov Model (HMM) that is a type of probability statistics method, and, depending on the embodiment, may be implemented in the HMM/DNN structure that combines HMM and the Deep Neural Network (DNN). Additionally, it may be implemented as a deep learning model based on the Recurrent Neural Network (RNN), the Convolutional Neural Network (CNN), and the transformer.

The decoder and language model m3 may generate a sequence for the natural text, based on the output of the time frame predicted by the acoustic model m2. Here, the decoder may generate various candidate sequences for characters, words, tokens, and the like by connecting the time frame outputs of the acoustic model m2, and may produce the acoustic model-based log probability for each candidate sequence. For example, when the candidate sequence is Y and the input speech is X, the acoustic model-based log probability may be logP_{AM}(Y|X).

In addition, the language model may produce a language model-based log probability by evaluating each candidate sequence, based on grammar or context. Here, the language model-based log probability may be logP_{LM}(Y).

Afterwards, the decoder may obtain an integrated log probability using the acoustic model-based log probability and the language model-based log probability, and may select the final sequence from among the candidate sequences using the integrated log probability. That is, the candidate sequence with the highest integrated log probability may be selected as the final sequence. In this case, the integrated log probability (Final LogScore(Y)) may be obtained using Final LogScore(Y)=logP_{AM}(Y|X)+λ·logP_{LM}(Y), where λ may be a weight for the language model.

The post-processor m4 may perform punctuation, spacing, case handling, and number normalization for the final sequence. That is, the final sequence may be processed into the readable sentence format before providing it to the user. For example, “Whatistheweatherliketoday?” may be converted to “What is the weather like today?” and provided.

As described above, the speech recognition model 210 may output, using input speech, text corresponding thereto. However, human speech may be inaccurate, and many distinct words may have identical or similar pronunciations, so the recognition accuracy of the speech recognition model 210 may be low for some words.

Previously, although accuracy was improved in a manner of new training such as fine-tuning the speech recognition model 210 depending on a specific environment in which speech occurs (e.g., telemedicine or online banking), this approach presented a problem in that time and cost are required for additional training. However, a technique has recently been introduced, in which, when individual words are specified and assigned boosting values without separate training, high log probabilities are assigned to the corresponding words during inference of the speech recognition model 210. That is, it is possible to improve the recognition rate for desired words by selecting and inputting the words, instead of spending significant time and money on fine-tuning.

Here, the speech recognition enhancement device 100 according to an embodiment of the present disclosure may generate a boosting list containing keywords to improve the recognition rate of the speech recognition device 200, and apply the boosting list to the speech recognition device 200, thereby increasing the recognition rate of the speech recognition device 200 for the corresponding keywords. At this time, the speech recognition enhancement device 100 may extract appropriate keywords for boosting, depending on the environment or location where the speech recognition device 200 is applied, and generate a boosting list.

In FIG. 1, since the speech recognition device 200 recognizes the speech of participants during a meeting session, the speech recognition enhancement device 100 may collect meeting information for the meeting session from the meeting management server S and configure keywords for boosting, and provide a boosting list generated based on this to the speech recognition device 200.

In this case, the speech recognition device 200 may adjust the log probability of keywords included in the boosting list, thereby improving the recognition accuracy of speech of the participants in the meeting session.

For example, proper nouns such as names of meeting participants, which may be frequently used during a meeting, are not words connected to other words but exist independently. Therefore, even if the speech recognition model 210 generate natural sentences, based on context and grammar, using a language model, it may be difficult to improve the accuracy of speech recognition for proper nouns themselves. In addition, if the name is similar in pronunciation to another word, the speech recognition device 200 may frequently misrecognize the name spoken by the participant as a different word.

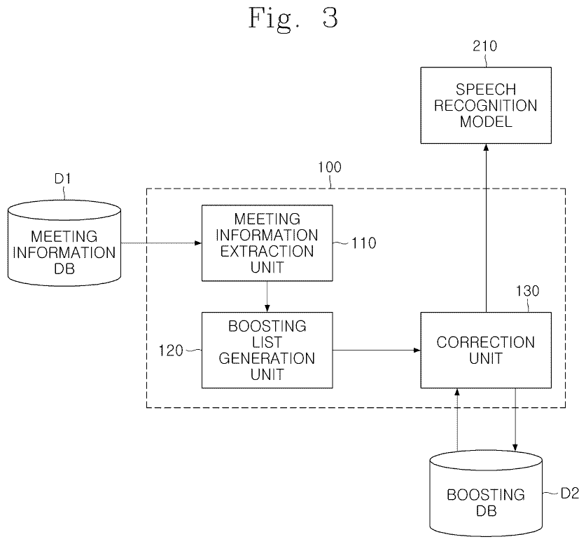

In this case, if the name is registered as a keyword using the speech recognition enhancement device 100, the speech recognition device 200 assigns a boosting value to the name, so that the name may be selected preferentially, thereby improving the recognition rate for the name during speech recognition. Hereinafter, a speech recognition enhancement device 100 according to an embodiment of the present disclosure will be described with reference to FIG. 3.

FIG. 3 is a block diagram illustrating a speech recognition enhancement device according to an embodiment of the present disclosure. Referring to FIG. 3, the speech recognition enhancement device 100 may include a meeting information extraction unit 110, a boosting list generation unit 120, and a correction unit 130.

The meeting information extraction unit 110 may extract meeting information corresponding to the meeting session held online. Here, the meeting information may include anything if it includes keywords for speech recognition.

Specifically, the meeting information extraction unit 110 may extract, as the meeting information, meeting session titles, agendas, and names, affiliations, connection locations, and connection times of participants. For example, the user may access the meeting management server S and generate a meeting session for the video meeting, and in this case, may input, to the meeting management server S, basic information for the meeting session, such as the meeting title, the agenda, and the names or affiliations of participants attending the meeting. Here, the meeting management server S may store basic information for each meeting session in the meeting information database D1 and manage the same, and the meeting information extraction unit 110 may extract basic information for each meeting session, as meeting information, from the meeting information database D1.

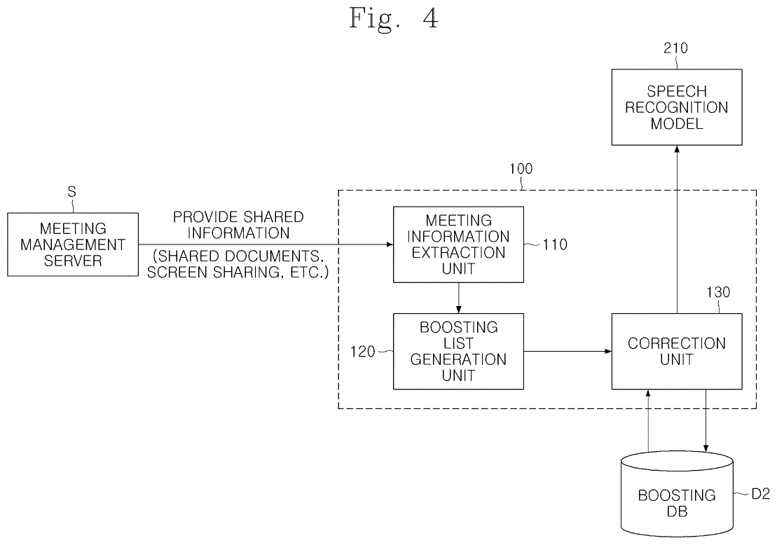

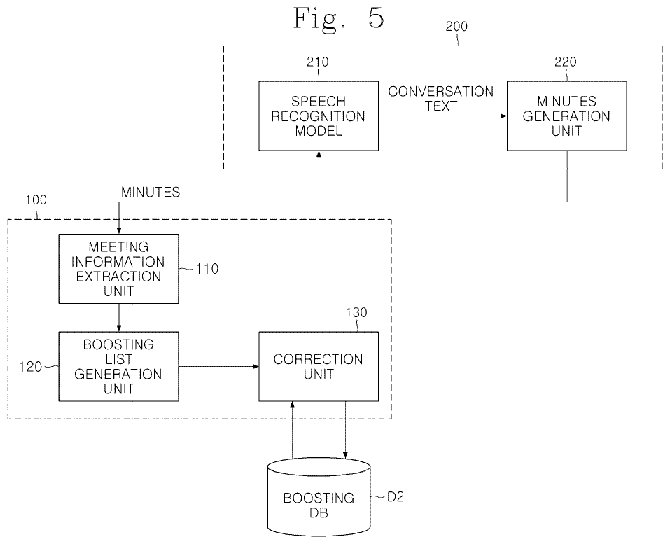

Additionally, as illustrated in FIGS. 4 and 5, the meeting information extraction unit 110 may also extract meeting information in real time from the information shared during the meeting session. Referring to FIG. 4, documents or screens may be shared between the participants during the meeting session, and at this time, the meeting management server S may collect the shared documents or screen capture images of the shared screen, and store them as shared information. In this case, the meeting information extraction unit 110 may access the meeting management server S and collect the shared information, and may extract meeting information from this. Depending on the embodiment, the meeting management server S may perform OCR (Optical Character Recognition) on the documents and the screen capture images shared during the meeting session, thereby generating document text and screen text corresponding thereto, and may store the generated document text and screen text as shared information. The meeting information extraction unit 110 may collect and extract the corresponding document text or screen text from the meeting management server S, as meeting information.

In addition, as illustrated in FIG. 5, the meeting information extraction unit 110 may receive minutes generated during the meeting session, and may also collect the minutes as meeting information. Referring to FIG. 5, the speech recognition device 100 may further include a minutes generation unit 220, and the minutes generation unit 220 may generate minutes by compiling respective conversation texts generated by the speech recognition model 210. Depending on the embodiment, the minutes generation unit 220 may also perform additional tasks such as summarizing or translating the generated minutes.

In this case, the minutes generation unit 220 may generate minutes from conversation texts using a large language model, and also verify and correct the minutes, based on the large language model. That is, the large language model may correct the minutes to produce feedback on the speech recognition results of the speech recognition model 210, and provide the corrected minutes to the meeting information extraction unit 110 so that the feedback is reflected back in the speech recognition model 210.

Specifically, the speech recognition enhancement device 100 may extract meeting information from the corrected minutes and extract keywords, based on the extracted meeting information, to update the boosting list. Through this, the speech recognition enhancement device 100 may induce the speech recognition model 210 to generate a speech recognition result corresponding to the corrected minutes. Depending on the embodiment, a human may verify and correct the minutes on behalf of the large language model.

The boosting list generation unit 120 may extract keywords from the meeting information, and may set keyword-specific boosting values corresponding to the extracted keywords, thereby generating the boosting list. Since the meeting information collected by the meeting information extraction unit 110 may include various information, important words or phrases may be extracted as keywords.

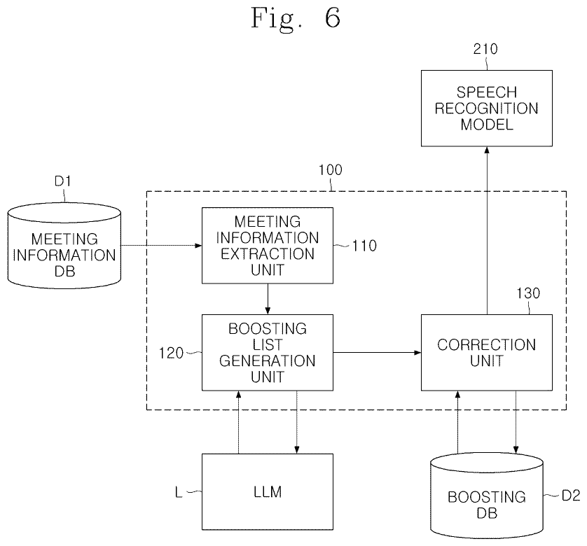

Specifically, the boosting list generation unit 120 may utilize a pre-trained machine learning model or a neural network model in order to extract the keywords from the meeting information. However, depending on the embodiment, the keywords may be extracted by utilizing a large language model. That is, as illustrated in FIG. 6, the prompt requesting for extracting keywords from the meeting information may be input to the large language model L, and the keywords corresponding thereto may be provided from the large language model L. For example, individual participant names may be extracted from the participant information and configured as keywords, or respective keywords may also be extracted from the meeting title or agenda.

Thereafter, the boosting list generation unit 120 may set a boosting value corresponding to each keyword. Here, each boosting value set for a keyword may be added to the log probability of each candidate sequence generated by the decoder and language model m3 of the speech recognition model 210. That is, when producing the final sequence, the final sequence may be obtained based on the integrated log probability, which is the sum of the acoustic model-based log probability (logP_{AM}(Y|X)) and the language model-based log probability (logP_{LM}(Y)), and the boosting value (Boost(Y)) may be added to the integrated log probability when calculating the integrated log probability. That is, the integrated log probability, including the boosting value, may be produced as follows:

$$Final Log Score ( Y ) = log {P}_{AM} ( Y \vert X ) + λ \cdot log {P}_{LM} ( Y ) + μ \cdot Boost ( Y )$$

Here, Boost(Y) may be a boosting value for the candidate sequence, and μ may be a weight for the boosting value. That is, since a boosting value is added to the integrated log probability of each keyword in the boosting list, the integrated log probability of the keyword may be set relatively high. Therefore, compared to other candidate sequences with similar integrated log probabilities, the candidate sequence corresponding to that keyword may be more likely to be selected as the final sequence.

Meanwhile, the boosting values may be set to the same preset value for the respective keywords. However, in some cases, it is also possible to differentiate the levels of the keywords and set different boosting values depending on the levels. For example, the boosting value ranges may be set to 5.0 to 10.0, 10.0 to 20.0, and 20.0 or higher. For relatively weak emphasis, the boosting value may be set to 5.0 to 10.0. For general emphasis, the boosting value may be set to 10.0 to 20.0. For strong emphasis, the boosting value may be set to 20.0 or higher. Depending on the embodiment, proper nouns, such as participants' names or specific brand names, may be set to values equal to or more than 20.0, while other general keywords may be set to values between 10.0 and 20.0.

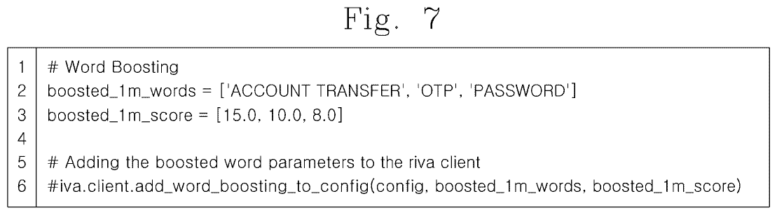

FIG. 7 is a diagram illustrating an example of setting a boosting value for each keyword according to an embodiment of the present disclosure. Referring to FIG. 7, the boosted keywords (boosted_lm_words) correspond to “account transfer,” “OTP,” and “password,” and boosting values (boosted_lm_score) corresponding to the respective keywords are “15.0,” “10.0,” and “8.0.” That is, it can be confirmed that “account transfer” is assigned a relatively high boosting value, while “password” is assigned a relatively low boosting value.

In addition, the boosting list generation unit 120 may store the boosting list generated from the corresponding meeting session in the boosting database D2. That is, the boosting lists for respective participants may be stored and managed in the boosting database D2. Therefore, if the same participant attends another meeting session, the past boosting list may be extracted and utilized from the boosting database D2. For example, the meeting information extraction unit 110 may extract the past boosting list for each participant who attended the meeting session from the boosting database D2 and extract meeting information from each past boosting list. That is, it may be utilized in a manner such as reconfiguring frequently used keywords in the past boosting list as keywords for the current meeting session.

The correction unit 130 may apply the boosting list to the speech recognition model 210, thereby increasing the recognition probability of the corresponding keywords in the speech recognition model 210. That is, the speech recognition model 210 may produce the log probabilities of multiple candidate sequences corresponding to the input speech, and then add a keyword-specific boosting value to the log probability of a candidate sequence corresponding to the corresponding keyword, among the multiple candidate sequences. That is, since the boosting value is added to the original log probability corresponding to the keyword, the probability that the speech recognition model 210 will select the candidate sequence corresponding to the keyword may be increased. Through this, when similar pronunciations are present, the corresponding keyword may be preferentially selected, thereby improving the speech recognition accuracy of the speech recognition model 210.

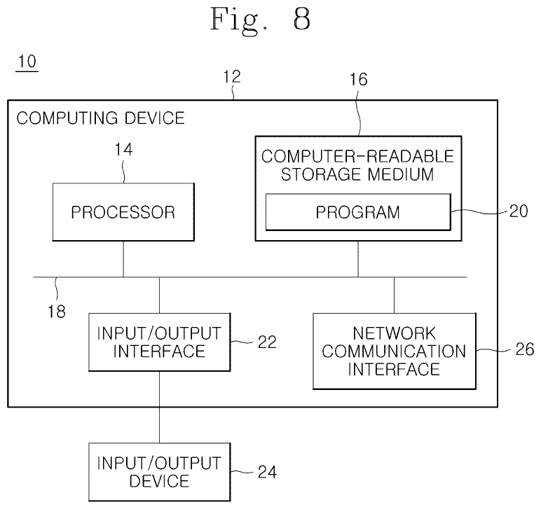

FIG. 8 is a block diagram illustrating a computing environment 10 suitable for use in exemplary embodiments of the present disclosure. In the illustrated embodiment, respective components may have different functions and capabilities from those described below, and may further include other components in addition to those described below.

The illustrated computing environment 10 includes a computing device 12. In an embodiment, the computing device 12 may be a speech recognition enhancement device 100 according to an embodiment of the present disclosure.

The computing device 12 includes at least one processor 14, a computer-readable storage medium 16, and a communication bus 18. The processor 14 may cause the computing device 12 to operate according to the embodiments described above. For example, the processor 14 may execute one or more programs stored on a computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions, program code, program data, and/or other suitable forms of information. The program 20 stored on the computer-readable storage medium 16 includes a set of instructions executable by the processor 14. In an embodiment, the computer-readable storage medium 16 may be memory (volatile memory, such as random-access memory, nonvolatile memory, or a suitable combination thereof), one or more magnetic disk storage devices, optical disk storage devices, flash memory devices, another type of storage medium capable of being accessed by the computing device 12 and storing desired information, or a suitable combination thereof.

The communication bus 18 interconnects various components of the computing device 12, including the processor 14 and the computer-readable storage medium 16.

The computing device 12 may also include one or more input/output interfaces 22 that provide interfaces for one or more input/output devices 24, and one or more network communication interfaces 26. The input/output interfaces 22 and the network communication interfaces 26 are connected to the communication bus 18. The input/output devices 24 may be connected to other components of the computing device 12 via the input/output interfaces 22. Examples of the input/output devices 24 may include input devices such as a pointing device (mouse, trackpad, etc.), a keyboard, a touch input device (touchpad, touchscreen, etc.), a voice or sound input device, various types of sensor devices, and/or photographing devices, and/or output devices such as a display device, a printer, a speaker, and/or a network card. The exemplary input/output device 24 may be included inside the computing device 12 as a component that constitutes the computing device 12, or may be configured as a separate device distinct from the computing device 12 and then connected to the computing device 12.

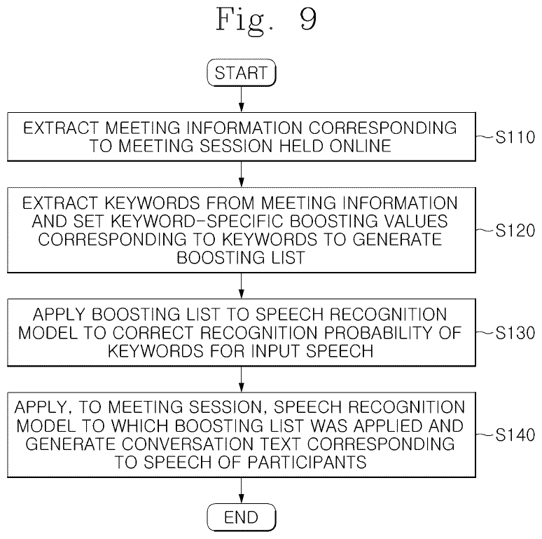

FIG. 9 is a flowchart illustrating a method for enhancing speech recognition based on meeting information according to an embodiment of the present disclosure. Here, the steps in FIG. 9 may be performed by the computing device according to an embodiment of the present disclosure.

Referring to FIG. 9, the computing device may extract meeting information corresponding to a meeting session held online (S110). Specifically, the computing device may extract, as meeting information, meeting session titles, agendas, and names, affiliations, connection locations, and connection times of participants. The user may create a meeting session for a video meeting. At this time, basic information for the meeting session may be entered, such as the meeting title, agenda, and participants'information, such as the names and affiliations of the participants attending the meeting. Therefore, the computing device may access the meeting information database of the meeting management server and extract basic information about the meeting session as meeting information.

In addition, depending on the embodiment, the computing device may also extract, as meeting information, document text extracted from documents shared in the meeting session, or screen text extracted from capture images of screens shared in the meeting session. That is, documents or screens may be shared between participants during the meeting session. In this case, the meeting management server may collect the shared documents or screen capture images of the shared screens, and store them as shared information. In this case, the computing device may access the meeting management server, collect the shared information, and extract meeting information therefrom. Depending on the embodiment, the meeting management server may perform OCR on the documents and screen capture images shared in the meeting session, generate document text and screen text corresponding thereto, respectively, and store the generated document text and screen text as shared information. Afterwards, the computing device may collect the document text or screen text from the meeting management server and extract it as meeting information.

After that, the computing device may extract keywords from the meeting information and set keyword-specific boosting values corresponding to the keywords to generate a boosting list (S120). In other words, since the meeting information collected by the computing device may contain a variety of information, important words or phrases may be extracted as keywords.

Specifically, the computing device may utilize a pre-trained machine learning model or a neural network model to extract keywords from the meeting information. However, depending on the embodiment, it is also possible to extract keywords utilizing a large language model. That is, a prompt requesting for extracting keywords from the meeting information may be input to the large language model, and the keywords corresponding thereto may be received from the large language model.

Once the keywords are extracted, the computing device may set boosting values corresponding to respective keywords. Here, the respective boosting values set for the keywords may be added to the log probabilities of respective candidate sequences generated by the decoder and language model of the speech recognition model. The boosting values may be set to the same preset value for the respective keywords. However, in some cases, it is also possible to differentiate the levels of the keywords and set different boosting values depending on the levels.

Next, the computing device may apply the boosting list to the speech recognition model to correct the recognition probability of the keywords for the input speech (S130). That is, the speech recognition model may produce log probabilities of multiple candidate sequences corresponding to the input speech, and then add a keyword-specific boosting value to the log probability of a candidate sequence corresponding to the corresponding keyword, among the multiple candidate sequences. That is, since the boosting value is added to the original log probability corresponding to the keyword, the probability that the speech recognition model will select the candidate sequence corresponding to the keyword may be increased. Through this, when similar pronunciations are present, the corresponding keyword may be preferentially selected.

In addition, the computing device may apply, to the meeting session, the speech recognition model to which the boosting list was applied, thereby generating conversation text corresponding to the participants' speech (S140). That is, the speech recognition model may perform speech recognition in the state where the log probabilities of keywords have been increased, thereby generating conversation text according thereto. Furthermore, the computing device may generate minutes for the meeting session including the conversation text. Depending on the embodiment, the computing device may also verify and correct the minutes, based on a large language model. In addition, it is possible to perform additional tasks, such as summarizing or translating the generated minutes.

Furthermore, the computing device may reuse the generated minutes as meeting information and update the boosting list based on this. Here, in a case where the large language model corrects the minutes, it may be considered that the large language model has generated feedback on the speech recognition results of the speech recognition model. Therefore, when meeting information is extracted from the corrected minutes so that the boosting list is updated, it is possible to reflect the feedback in the speech recognition model. Depending on the embodiment, a human may perform verification and correction of minutes on behalf of the large language model.

In addition, the computing device may store the boosting list corresponding to the meeting session in the boosting database. That is, the computing device may extract, from the boosting database, the previous boosting list for each participant in the meeting session, and may also extract meeting information from the previous boosting list. Through this, the computing device may reconfigure frequently used keywords in the previous boosting list as keywords for the current meeting session.

The present disclosure described above may be implemented as a computer-readable code on a medium in which a program is recorded. The computer-readable medium may be a medium that continuously stores a computer-executable program or temporarily stores it for execution or download. In addition, the medium may be a variety of recording means or storage means in the form of a single or multiple hardware combinations, and is not limited to a medium directly connected to a computer system, but may also be distributed on a network. Examples of the media may include magnetic media such as hard disks, floppy disks, and magnetic tapes, optical recording media such as CD-ROMs and DVDs, magneto-optical media such as floptical disks, and ROMs, RAMs, flash memories, etc., which are configured to store program instructions. In addition, examples of other media include recording media or storage media managed by App store that distribute applications, or sites or servers that supply or distribute various software. Therefore, the above detailed description should not be construed as limiting the disclosure in all respects and should be considered as examples. The scope of the present disclosure should be determined by a reasonable interpretation of the appended claims, and all changes within the equivalent scope of the present disclosure are included in the scope of the present disclosure.

The present disclosure is not limited to the above-described embodiments and the attached drawings. It will be apparent to those skilled in the art to which the present disclosure belongs that components according to the present disclosure may be substituted, modified, and changed without departing from the technical idea of the present disclosure.

What is claimed is:

1. A method for enhancing speech recognition based on meeting information using a computing device, the method comprising:
extracting meeting information corresponding to a meeting session held online;
extracting keywords from the meeting information and setting keyword-specific boosting values corresponding to the keywords to generate a boosting list; and
applying the boosting list to a speech recognition model to increase a recognition probability of the keywords for input speech.

2. The method for enhancing speech recognition based on meeting information of claim 1, wherein the extracting of the meeting information comprises
extracting at least one of a meeting session title, an agenda, names, affiliations, connection locations, and connection times of participants as the meeting information.

3. The method for enhancing speech recognition based on meeting information of claim 1, wherein the extracting of the meeting information comprises
extracting, as the meeting information, document text extracted from a document shared in the meeting session or screen text extracted from a screen capture image of a screen shared in the meeting session.

4. The method for enhancing speech recognition based on meeting information of claim 1, wherein the generating of the boosting list comprises
inputting the meeting information into a large language model (LLM) and requesting extraction of keywords corresponding thereto.

5. The method for enhancing speech recognition based on meeting information of claim 1, wherein the speech recognition model is configured to
produce log probabilities of multiple candidate sequences corresponding to the input speech, and then add the keyword-specific boosting value to a log probability of a candidate sequence corresponding to the keyword, among the multiple candidate sequences.

6. The method for enhancing speech recognition based on meeting information of claim 1, further comprising
generating conversation text corresponding to speech of participants in the meeting session using the speech recognition model to which the boosting list has been applied.

7. The method for enhancing speech recognition based on meeting information of claim 6, wherein the generating of the conversation text comprises:
generating minutes for the meeting session, which include the conversation text; and
verifying and correcting the minutes, based on a large language model.

8. The method for enhancing speech recognition based on meeting information of claim 7, wherein the extracting of the meeting information comprises
extracting the meeting information from the minutes.

9. The method for enhancing speech recognition based on meeting information of claim 1, further comprising
storing the boosting list corresponding to the meeting session in a boosting database.

10. The method for enhancing speech recognition based on meeting information of claim 9, wherein the extracting of the meeting information comprises
extracting a previous boosting list for each participant in the meeting session from the boosting database, and extracting the meeting information from the previous boosting list.

11. The method for enhancing speech recognition based on meeting information of claim 10, wherein the generating of the boosting list comprises
reconfiguring frequently used keywords in the previous boosting list as keywords for the meeting session.

12. A computer program stored on a computer-readable medium for executing, in conjunction with hardware, the method for enhancing speech recognition based on meeting information of claim 1.

13. A computing device performing meeting information-based speech recognition enhancement, the computing device comprising a processor,
wherein the processor is configured to:
extract meeting information corresponding to a meeting session held online;
extract keywords from the meeting information and set keyword-specific boosting values corresponding to the keywords to generate a boosting list; and
apply the boosting list to a speech recognition model to increase a recognition probability of the keywords for input speech.

14. The computing device of claim 13, wherein the extracting of the meeting information comprises
extracting at least one of a meeting session title, an agenda, names, affiliations, connection locations, and connection times of participants as the meeting information.

15. The computing device of claim 13, wherein the extracting of the meeting information comprises
extracting, as the meeting information, document text extracted from a document shared in the meeting session or screen text extracted from a screen capture image of a screen shared in the meeting session.

16. The computing device of claim 13, wherein the generating of the boosting list comprises
inputting the meeting information into a large language model (LLM) and requesting extraction of keywords corresponding thereto.

17. The computing device of claim 13, wherein the speech recognition model is configured to
produce log probabilities of multiple candidate sequences corresponding to the input speech, and then add the keyword-specific boosting value to a log probability of a candidate sequence corresponding to the keyword, among the multiple candidate sequences.

18. The computing device of claim 13, wherein the processor is further configured to
generate conversation text corresponding to speech of participants in the meeting session using the speech recognition model to which the boosting list has been applied.

19. The computing device of claim 13, wherein the processor is further configured to
store the boosting list corresponding to the meeting session in a boosting database.

20. The computing device of claim 19, wherein the extracting of the meeting information comprises
extracting a previous boosting list for each participant in the meeting session from the boosting database, and extracting the meeting information from the previous boosting list.
